(19) United States
(12) Patent Application Publication
(10) Pub. No.: US 2003/0091962 A1
(43) Pub. Date: May 15, 2003

(54) Color card structure

(76) Inventor: Chin-Chuan Hung, Taichung city (TW)

Correspondence Address: TROXELL, ONE SKYLINE PLACE, SUITE 1404, 5205 LEESBURG PIKE, FALLS CHURCH, VA, 22041, US

(21) Appl. No.: 10/253,718

(22) Filed: Sep. 25, 2002

(30) Foreign Application Priority Data
Nov. 13, 2001 (TW) 090219458

(51) Int. Cl. G09B 11/10

(52) U.S. Cl. 434/84

(57) ABSTRACT

Color card structure including a substrate and at least one block display section with predetermined color arranged on one face of the substrate. The display section is divided into an original color area showing the original predetermined color and at least one processed area showing a brightness of the predetermined color after specifically processed.

### BACKGROUND OF THE INVENTION

The present invention is related to a color identifying tool, and more particularly to an improved color card structure.

A conventional color card is made of a hard board body with a certain strength as a substrate. Specific colors are printed on the substrate for a user to identify and choose. In order to facilitate the identification, the colors pertaining to the same color series with different thickness are gradationally shown for the user to choose a desired color from a color series.

The above color card enables a user to identify a specific color among gradated colors or mixed colors. However, in practice, in order to achieve variation of visual effect and meet the special requirement of the property of a product, it is often necessary to further process the color layer. For example, the color layer can be polished or fogged to achieve different visual effect. More importantly, after processed, the color layer will present a brightness different from the original color. However, the conventional color card fails to provide the visual effect of the specific color after specifically processed. The user can truly see the processed color only after actually processed. In case the processed color fails to meet the requirement, the processing cost will be wasted.

### SUMMARY OF THE INVENTION

It is therefore a primary object of the present invention to provide an improved color card structure which not only shows the original color, but also further shows the modified color after specifically processed. Therefore, a user can truly identify and choose the desired color.

According to the above object, the color card structure includes a substrate and at least one block display section with predetermined color arranged on one face of the substrate. The display section is divided into an original color area showing the original predetermined color and at least one processed area showing a brightness of the predetermined color after specifically processed.

The present invention can be best understood through the following description and accompanying drawings wherein:

### BRIEF DESCRIPTION OF THE DRAWING

FIG. 1 is a plane view of a preferred embodiment of the present invention.

### DETAILED DESCRIPTION OF THE PREFERRED EMBODIMENTS

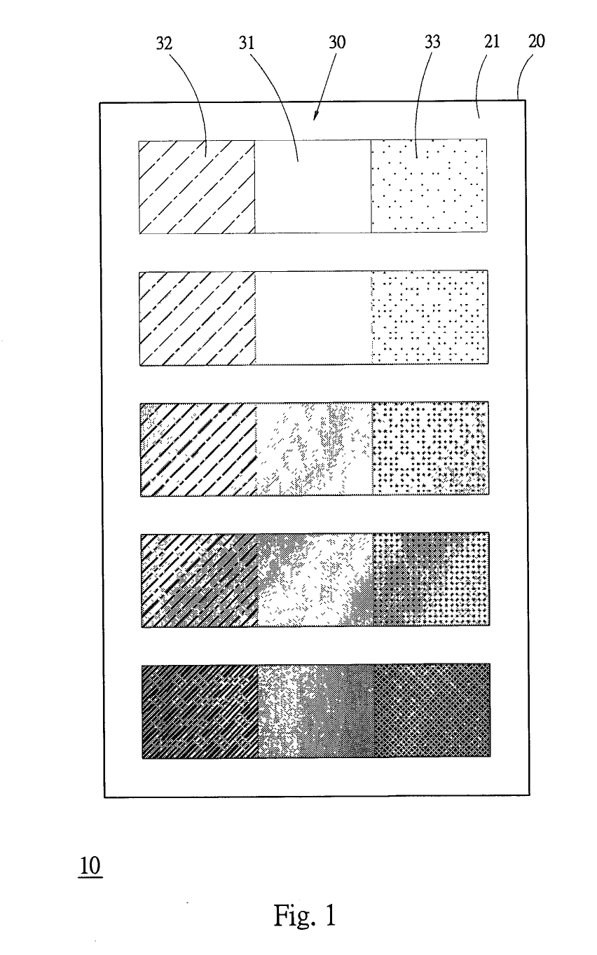

Please refer to FIG. 1. The color card structure 10 of the present invention includes a substrate 20 and multiple display sections 30 with different colors.

The substrate 20 is made of a stiff material such as paper board or polymer material. No matter what material the substrate 20 is made, the color display should not be affected. In other words, the background color had best white.

The display sections 30 are rectangular blocks and side by side arranged on one face 21 of the substrate 20 at intervals. The display sections 30 respectively have predetermined colors. More specifically, the colors pertaining to the same color series with different thickness are respectively shown on the display sections 30 side by side. Accordingly, a user can select a desired color. In addition, along the length of the rectangular block, each display section 30 is divided into a central original color area 31 showing the original color prior to processing, a polished area 32 on one side of the original color area 31 and a fogged area 33 on the other side thereof. The polished area 32 and the fogged area 33 respectively show different brightness after polished and fogged for the user to further compare.

Accordingly, in addition to the conventional original color area 31, the color card 10 of the present invention further includes the polished area 32 and fogged area 33 respectively arranged on two sides of the original color area 31 to show different brightness for a user to choose. Therefore, when the user selects a specific color and desires further processing of the color to meet the specific requirement, the user can immediately and accurately judge the visual effect of the color after polished, fogged or otherwise processed. Therefore, it is unnecessary for the user to know whether the processed color is truly the needed one after actually processed. Therefore, it is avoided that the visual effect of the actually processed color fails to meet the requirement so that the waste of resource is avoided.

The above embodiments are only used to illustrate the present invention, not intended to limit the scope thereof. Many modifications of the above embodiments can be made without departing from the spirit of the present invention.

What is claimed is:

1. Color card structure comprising a substrate and at least one block display section with predetermined color arranged on one face of the substrate, said color card structure being characterized in that the display section is divided into an original color area showing the original predetermined color and at least one processed area showing a brightness of the predetermined color after specifically processed.

2. Color card structure as claimed in claim 1, wherein multiple display sections are side by side arranged on one face of the substrate at intervals.

3. Color card structure as claimed in claim 1, wherein each display section includes two processed areas which are processed by different measures for showing different brightness.

4. Color card structure as claimed in claim 3, wherein the original color area is sandwiched between the two processed areas.
